(19) United States
(12) Patent Application Publication
(10) Pub. No.: US 2025/0004316 A1
(43) Pub. Date: Jan. 2, 2025

(54) ANTI-GLARE COMPOSITIONS, ANTI-GLARE FILMS, POLARIZERS, AND DISPLAY DEVICES

(71) Applicant: SHENZHEN CHINA STAR OPTOELECTRONICS SEMICONDUCTOR DISPLAY TECHNOLOGY CO., LTD., Shenzhen (CN)

(72) Inventor: Aibing BAO, Shenzhen (CN)

(21) Appl. No.: 18/400,587

(22) Filed: Dec. 29, 2023

(30) Foreign Application Priority Data
Jun. 29, 2023 (CN) 202310786820.7

(51) Int. Cl. G02F 1/1335; G02B 1/111

(52) U.S. Cl. CPC G02F 1/133502; G02B 1/111

(57) ABSTRACT

An anti-glare composition, an anti-glare film, a polarizer, and a display device are provided by the present disclosure. The anti-glare composition includes a resin and a surface modified particle. The surface modified particle includes a first particle, a second particle, and a hydrophobic modified group. The hydrophobic modified group is connected to both the first particle and the second particle through chemical bonds. A particle diameter of the first particle is larger than a particle diameter of the second particle.

### CROSS-REFERENCE TO RELATED APPLICATION

The present disclosure claims priority to and the benefit of Chinese Patent Application No. 202310786820.7, filed on Jun. 29, 2023, the disclosure of which is incorporated herein by reference in its entirety.

### TECHNICAL FIELD

The present disclosure relates to display technologies, and in particular to anti-glare compositions, anti-glare films, polarizers, and display devices.

### BACKGROUND

In liquid crystal display panels, in order to reduce the interference and glare caused by external light, it is necessary to apply anti-glare treatment to the surface of the display panel to eliminate human shadows and reduce reflected light. Generally, an anti-glare resin film is disposed on the surface of the display panel, and large-sized inorganic silicon oxide particles are added to the resin to form a fine concave convex surface on the surface of the anti-glare resin film.

In the research and practice of existing technologies, the inventors of this application have found that due to the abundant hydroxyl groups on the surface of inorganic silicon oxide particles, and the hydroxyl groups have very high surface energy. After mixed with resin, the inorganic silicon oxide particles tend to be evenly distributed inside the resin layer, unable to aggregate to the surface, and unable to form a complete concave convex surface, resulting in poor anti-glare performance. In addition, larger-sized particles lead to poor wear resistance, which can cause scratches on the surface of the display panel during use.

In summary, the existing anti-glare resin film needs to be improved.

### SUMMARY

The embodiments of the present disclosure provide an anti-glare composition. The anti-glare composition includes a resin and a surface modified particle. The surface modified particle includes a first particle, a second particle, and a hydrophobic modified group. The hydrophobic modified group is connected to both the first particle and the second particle through chemical bonds. A particle diameter of the first particle is larger than a particle diameter of the second particle.

The embodiments of the present disclosure further provide an anti-glare film. The anti-glare film includes a substrate and an anti-glare layer disposed on the substrate. The anti-glare layer is manufactured by the anti-glare composition provided by the above embodiments. The anti-glare layer includes an uneven surface.

The embodiments of the present disclosure further provide a polarizer. The polarizer includes a polarizing layer and the anti-glare film provided by the above embodiments. The anti-glare film is disposed on a light emitting side of the polarizing layer.

The embodiments of the present disclosure further provide a display device. The display device includes a display panel and a polarizer provided by the above embodiments. The polarizer is disposed on a light emitting side of the display panel.

### BRIEF DESCRIPTION OF THE DRAWINGS

To describe the technical solutions of the embodiments of the present disclosure more clearly, the following briefly introduces the accompanying drawings used in the description of the embodiments of the present disclosure. Apparently, the accompanying drawings described below illustrate only some exemplary embodiments of the present disclosure, and persons skilled in the art may derive other drawings from the drawings without making creative efforts.

FIG. 1 is a schematic view of an anti-glare film provided by an embodiment of the present disclosure.

FIG. 2 is a schematic view of a polarizer provided by an embodiment of the present disclosure.

### DETAILED DESCRIPTION

The technical solutions in the embodiments of the present disclosure will be described clearly and completely hereafter with reference to the accompanying drawings. Apparently, the described embodiments are only a part of but not all embodiments of the present disclosure. All other embodiments obtained by persons of ordinary skill in the art based on the embodiments of the present disclosure without creative efforts shall fall in the protection scope of the present disclosure.

The embodiments of the present disclosure provide an anti-glare composition, an anti-glare film, a polarizer, and a display device. The following are detailed explanations. It should be noted that the description order of the following embodiments does not serve as a limitation on the preferred order of embodiments. Furthermore, in the description of the present disclosure, term “including” refers to “including but not limited to”. Terms “first”, “second”, and “third” are only used as indications and do not impose numerical requirements or establish order. Various embodiments of the present disclosure may exist in a range of forms. It should be understood that the description in the form of a scope is only for convenience and conciseness, and should not be understood as a rigid limitation on the scope of the present disclosure. Therefore, it should be considered that the range description has specifically disclosed all possible sub ranges and a single value within the range. For example, it should be considered that the range description from 1 to 6 has specifically disclosed sub ranges, such as from 1 to 3, from 1 to 4, from 1 to 5, from 2 to 4, from 2 to 6, from 3 to 6, etc., as well as single numbers within the range, such as 1, 2, 3, 4, 5, and 6, regardless of the range. In addition, whenever a numerical range is mentioned in this article, it refers to any referenced number (fraction or integer) within the specified range.

In some exemplary techniques, an anti-glare film with fine concave convex surfaces are disposed on a surface of a display device. The implementation of such concave convex surfaces is usually achieved by adding large-sized particles into the resin film layer. Considering the influence of light scattering caused by a difference in refractive index between the resin and the particles, inorganic silica particles are generally chosen. However, due to the abundant hydroxyl groups on the surface of inorganic silicon oxide particles, which have a very high surface energy, when mixed with the resin, the particles tend to be evenly distributed inside the film layer, unable to aggregate towards the surface of the film layer, and unable to form a continuous fine concave convex surface, which greatly weakens the anti-glare performance. In addition, due to the large size of the silicon oxide particles on the surface of the film layer, their wear resistance is also poor, which may cause scratches on the surface of the display during use.

In response to the above-mentioned defects, the embodiments of the present disclosure provide an anti-glare composition. The present anti-glare composition includes a resin and surface modified particles. The surface modified particle includes a first particle, a second particle, and a hydrophobic modified group. The hydrophobic modified group is connected to both the first particle and the second particle through chemical bonds. A particle diameter of the first particle is larger than a particle diameter of the second particle.

The particles of the anti-glare composition provided by the embodiments of the present disclosure are modified by using hydrophobic modification groups to connect the large-sized first particle and the small-sized second particles, and hydrophobically modifying the two types of particles. On the one hand, the surface energy of the modified particles is reduced. When manufacturing the anti-glare film, the modified particles will aggregate towards the surface of the film. The large-sized first particle may form a continuous concave convex surface, which can effectively achieve anti-glare effect. On the other hand, the small-sized second particle aggregates around the large-sized first particle through chemical bonds. Due to the high particle hardness of the small-sized second particle, it is difficult to be crushed by external forces to damage the structure, so the anti-glare composition has excellent wear resistance.

In some embodiments of the present disclosure, the refractive index of the resin ranges from 1.4 to 1.6. In order to suppress the light scattering phenomenon caused by the particles and the resin, the smaller the difference in refractive index between the first and second particles selected and the resin, the better. The refractive index of the first and second particles selected in the embodiments of the present disclosure also ranges from 1.4 to 1.6.

In some embodiments, the particle diameter of the first particle ranges from 1 μm to 10 μm. Furthermore, the particle diameter of the first particle ranges from 3 μm to 6 μm. The particle diameter of the first particle may be 1 μm, 1.5 μm, 2 μm, 2.5 μm, 3 μm, 3.5 μm, 4 μm, 4.5 μm, 5 μm, 5.5 μm, 6 μm, 6.5 μm, 7 μm, 7.5 μm, 8 μm, 8.5 μm, 9 μm, 9.5 μm, or 10 μm.

In some embodiments, the particle diameter of the second particle ranges from 10 nm to 100 nm. Furthermore, the particle diameter of the second particle ranges from 40 nm to 60 nm. Optionally, the particle diameter of the second particle may be 10 nm, 20 nm, 30 nm, 35 nm, 40 nm, 42 nm, 46 nm, 48 nm, 50 nm, 52 nm, 54 nm, 56 nm, 58 nm, 60 nm, 65 nm, 70 nm, 75 nm, 80 nm, 85 nm, 95 nm or 100 nm.

Choosing the first particle and the second particle with the above particle sizes may ensure that the large-sized first particle forms a concave convex surface, playing a better anti-glare effect, while also ensuring that the small-sized second particle has a higher hardness, avoiding deformation of the film caused by external force compression, and achieving good wear resistance and friction performance.

In some embodiments, the surface modified particles can be hydrophobic modified on the surface of the first and second particles through silane coupling agents to reduce the surface energy of the first and second particles, causing the surface modified particles to tend to aggregate on the surface of the film. The first particles with large particle sizes can form a continuous concave convex surface, playing an anti-glare role.

In some embodiments, materials of the first particle and the second particle may be same or different. Optionally, both the first particle and the second particle are selected from silica particles.

Furthermore, the hydrophobic modified group includes a plurality of carbon-carbon double bonds, and a cross-linked network structure may be formed by the surface modified particles having the carbon-carbon double bonds and the resin and/or a reactive monomer in the anti-glare composition. Specifically, the first particle and the second particle are chemically modified to form the surface modified particle. The surface modified particles having a plurality of double bonds that can undergo free radical reactions can react with functional groups of the resin and/or the reactive monomer to form a complete cross-linked network structure with the resin and/or the reactive monomer, which can further improve the hardness and friction resistance of the film. Specifically, the resin or the reactive monomer includes acryloyloxy groups, which may react with carbon-carbon double bonds to form a cross-linked network structure.

Specifically, in some embodiments, the structural formula of the surface modified particles is shown in formula (1).

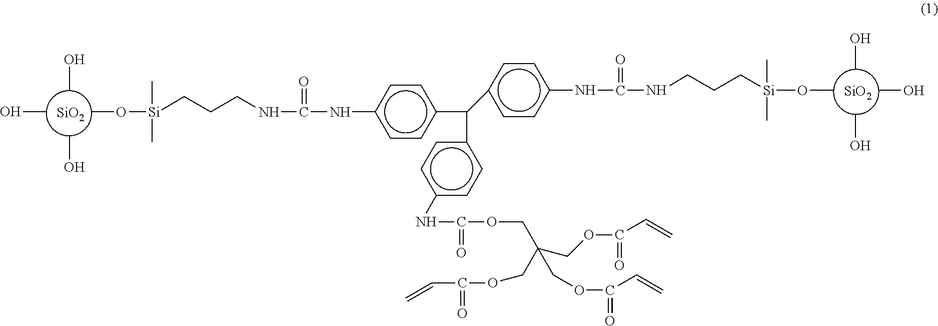

In the above structural formula, the SiO₂ on the left represents the first particle with a large particle size, and the SiO₂ on the right represents the second particle with a small particle size. In other embodiments, the first particle and the second particle may be other types of particles. The structural formula of hydrophobic groups is as follows.

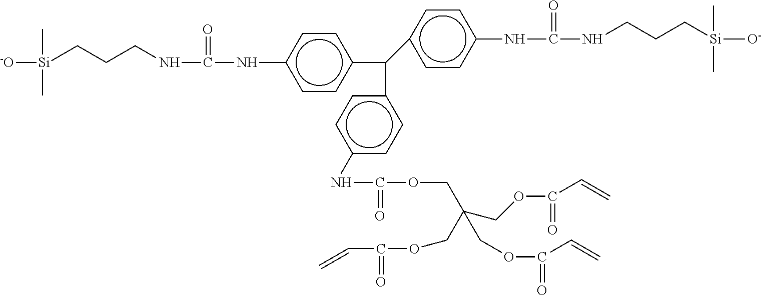

Due to the fact that in existing technology, some of the raw materials for silicon oxide particles are derived from silicic acid. Silicon oxide is produced through dehydration and condensation of silica, which usually does not react completely, resulting in the presence of hydroxyl groups on the surface of silicon oxide. The presence of hydroxyl groups in different bonding states on the surface of silicon oxide results in its high surface energy. Hydrophobic modification of the first particle and the second silica particle may be achieved by using silane coupling agents (taking 3-aminopropyl dimethylethoxysilane as an example below) to reduce their surface energy, to ensure that the large-sized first silica particles may aggregate towards the surface of the film and form a continuous concave convex structure on the surface of the film.

Furthermore, a surface treatment is carried out on the first silica particle and the second silica particle using trimethylbenzene diisocyanate after hydrophobic treatment, so that the first silica particle and the second silica particle can be chemically bonded after hydrophobic treatment.

Furthermore, pentaerythritol triacrylate is used to modify the first silica particle and the second silica particle that are chemically bonded to each other and hydrophobic treated, resulting in the final modified silica particle containing carbon-carbon double bonds. This allows the surface modified particles to form a cross-linked network structure with the resin.

Specifically, the formation mechanism of the surface modified particles shown in formula (1) above is as follows: reaction equations I, II, III, and IV.

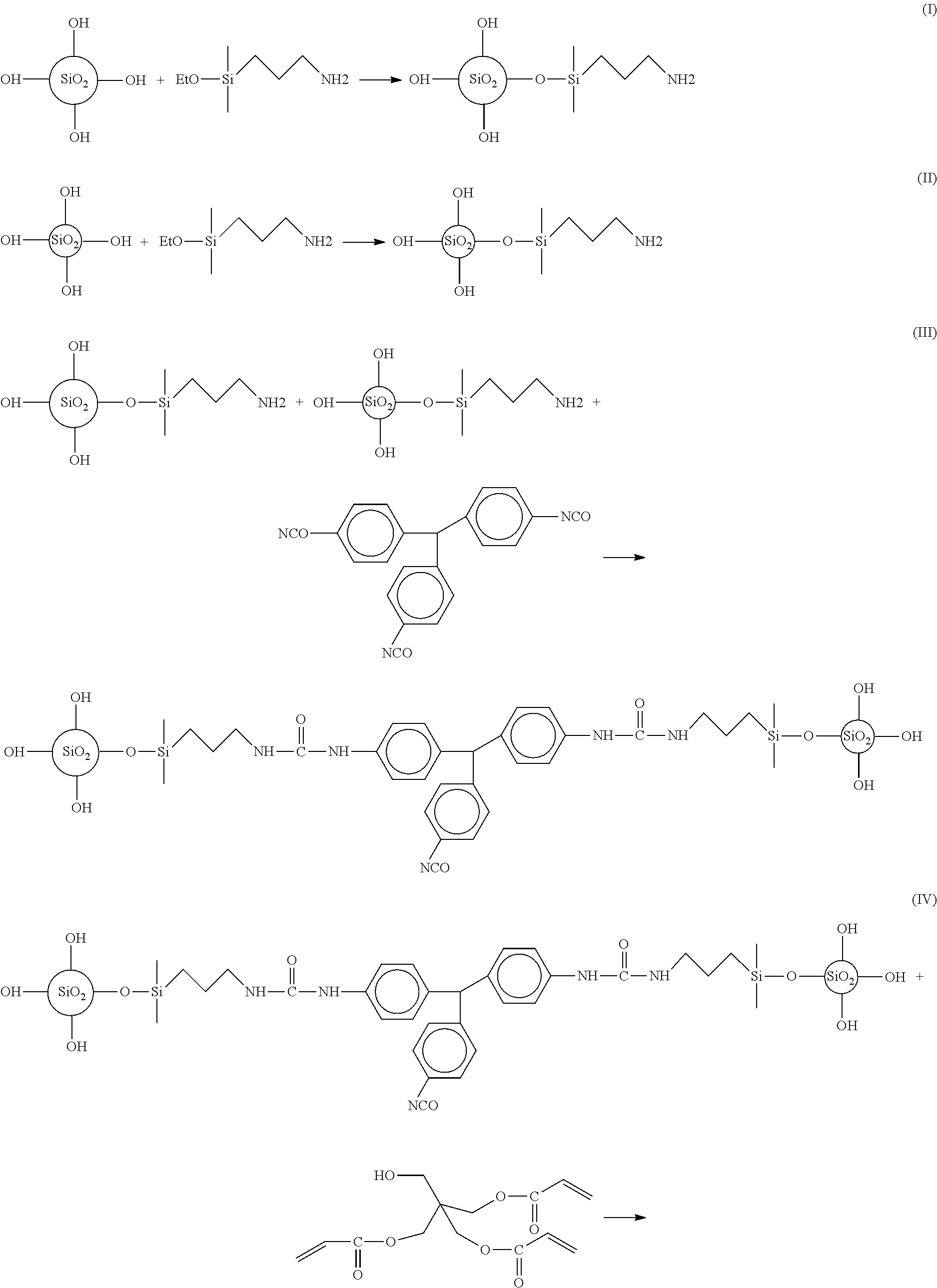

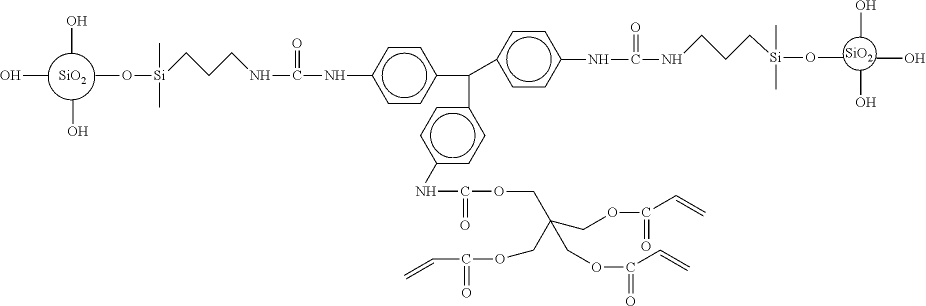

Specifically, a manufacturing process of the surface modified particle shown in the above formula (1) includes steps S1 to S4. At step S1, the first silica particle with hydroxyl groups on the surface is modified by 3-aminopropyl dimethylethoxysilane, as shown in reaction equation I. At step S2, the second silica particle with hydroxyl groups on the surface is modified by 3-aminopropyl dimethylethoxysilane, as shown in reaction equation II. At step S3, the first silica particle and the second silica particle after modification are modified by trimethylbenzene diisocyanate, to connect the first silica particle and the second silica particle through chemical bonds, as shown in reaction equation III. At step S4, the first silica particle and the second silica particle connected to each other by chemical bonds are modified by pentaerythritol triacrylate, to obtain the surface modified particle containing carbon-carbon double bonds, as shown in reaction equation IV.

At step S1, the first silica particles with the particle diameter ranging from 1 μm to 10 μm are mixed with hydrochloric acid (HCl), ultrapure water (water with a resistivity of 18 MΩ*cm (25° C.)), and tetrahydrofuran, and they are sonicated for 0.5-1.5 hours. Then 3-aminopropyldimethylethoxysilane is added, inert gas is introduced, and a mixture is obtained by stirring at 55-65° C. for 20-26 hours. Next, the mixture is separated into a colorless aqueous phase and a turbid organic phase containing the product. Finally, the organic phase is subjected to evaporation, extraction, drying, and filtration to obtain an oily product, which is the product of reaction equation I.

The specific steps of step S2 are similar to those of step S1, except that the particle diameter of the second silica particle ranges from 10 nm to 100 nm.

At step S3, the products prepared from step S1 and step S2 are mixed with trimethylbenzene diisocyanate, tetrahydrofuran, dibutyltin dilaurate, and p-hydroxybenzyl ether. Then inert gas is introduced and stirred at 35-45° C. for 4-6 hours to obtain the product shown in reaction equation III.

At step S4, the product prepared by step S3 is mixed with pentaerythritol triacrylate, tetrahydrofuran, dibutyltin dilaurate, and p-hydroxybenzyl ether. Then inert gas is introduced and stirred at 35-45° C. for 4-6 hours to obtain the product shown in reaction equation IV.

In the embodiment of the present disclosure, calculated by 100 parts by weight of the resin, the anti-glare composition includes the resin having 100 parts, the surface modified particle having 5 to 25 parts, a reactive monomer having 5 to 30 parts, and an initiator having 1 to 10 parts.

In some embodiments, the resin may be a light cured resin. A functional degree of the resin is greater than or equal to 5. A higher functional degree enables the formation of a network structure with a higher crosslinking density between the resin and the surface modified particles, improving mechanical properties.

The resin includes but is not limited to at least one of polyester acrylic resin, polyurethane acrylic resin, epoxy acrylic resin, and poly (silsesquioxane) resin.

In some embodiments, the reactive monomer may be a photocurable monomer. A functionality of the reactive monomer is greater than or equal to 3. The higher functionality ensures the formation of a network structure with a higher crosslinking density between the resin formed by the polymerization of the reactive monomer and the surface modified particles, improving mechanical properties.

The reactive monomer may be tri-functional (meth)acrylates, including but not limited to at least one of trimethylolethane tri(meth)acrylate, trimethylolpropane tri(meth)acrylate, glycerol tri(meth)acrylate, pentaerythritol tri(meth)acrylate, di(trimethylolpropane) tri(meth)acrylate, and dipentaerythritol tri(meth)acrylate.

The reactive monomer may be multi-functional (meth)acrylates with four or more functions, including but not limited to at least one of pentaerythritol tetra(meth)acrylate, di(trimethylolpropane) tetra(meth)acrylate, dipentaerythritol tetra(meth)acrylate, dipentaerythritol penta(meth)acrylate, di(trimethylolpropane) penta(meth)acrylate, dipentaerythritol hexa(meth)acrylate, and di(trimethylolpropane) hexa(meth)acrylate.

In some embodiments, the initiator may be a photo-initiator. The photo-initiator includes at least one of a type I photo-initiator and a type II photo-initiator. The type I photo-initiator causes molecular decomposition to produce free radicals due to differences in chemical structure or molecular binding energy. The type II photo-initiator is a hydrogen withdrawing photo-initiator, which introduces tertiary amine as a co-initiator.

The type I photo-initiator includes at least one of an acetophenone-based initiator, acyl phosphine oxide, titanocene, and a benzoin-based compound. The cetophenone-based initiator includes but is not limited to at least one of 4-phenoxydichlorophenone, 4-tert butyldichlorophenone, 4-tert butyltrichlorophenone, diethylacetophenone, 2-hydroxy-2-methyl-1-phenylpropane-1-one, 1-(4-isopropylphenyl)-2-hydroxy-2-methylpropane-1-one, 1-(4-dodecylphenyl)-2-hydroxy-2-methylpropane-1-one, 4-(2-hydroxyethoxy)-phenyl-(2-hydroxy-2-propyl) ketone, 1-hydroxycyclohexyl phenyl ketone, etc. The benzoin-based compound may be at least one of benzoin, benzoin methyl ether, benzoin ether, and benzyl dimethyl ketal.

The type II photo-initiator includes at least one of a benzophenone-based initiator and a thioxanthone-based initiator. The benzophenone-based initiator includes at least one of benzophenone, benzoylbenzoic acid, benzoylbenzoic acid methyl ether, 4-phenylbenzophenone, hydroxybenzophenone, 4-benzoyl-4′-methyldiphenyl sulfide, and 3,3′-dimethyl-4-methoxy benzophenone. The thioxanthone-based initiator includes at least one of thioxanthone, 2-chlorothioxanthone, 2-methylthioxanthone, 2,4-dimethylthioxanthone, and isopropylthioxanthone.

The anti-glare composition further includes 1-10 parts of solvent. The solvent selected is a solvent with a boiling point ranging from 50° C. to 150° C. If the boiling point is below 50° C., the solvent volatility is strong, and the resin curing and coating thickness may be affected. If the boiling point is higher than 150° C., it affects the drying efficiency and leads to an increase in cost. The solvent includes at least one of an alcohol-based solvent, an ester-based solvent, a ketone-based solvent, and a benzene-based solvent. The alcohol-based solvent includes but is not limited to at least one of methanol, ethanol, and isopropanol. The ester-based solvent includes but is not limited to at least one of ethyl acetate, propyl acetate, and butyl acetate. The ketone-based solvent includes but is not limited to at least one of acetone, butanone, and cyclohexanone. The benzene-based solvent includes but is not limited to at least one of toluene and xylene.

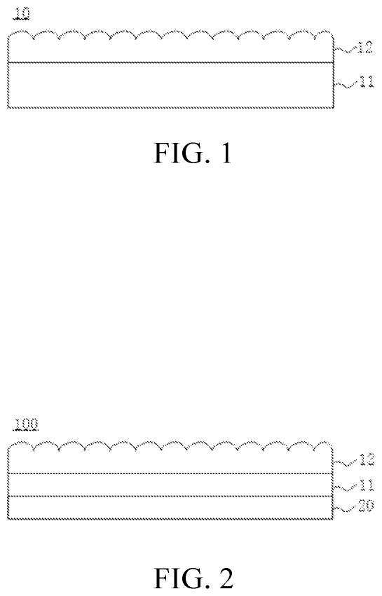

Based on the anti-glare composition in the above embodiments, as shown in FIG. 1, the present disclosure further provides an anti-glare film 10. The anti-glare film 10 includes a substrate 11 and an anti-glare layer 12 disposed on the substrate 11. The anti-glare layer 12 includes the anti-glare composition in the above embodiments. The anti-glare layer 12 includes an uneven surface. When coating the anti-glare composition on the substrate 11, due to the reduced surface energy of the modified particles in the anti-glare composition, the modified particles is capable of aggregating towards the surface of the formed film, forming a continuous concave convex structure on the surface of the film during curing, and forming a cross-linked network structure with the resin and/or reactive monomer in the composition. So the prepared anti-glare layer may effectively achieve anti-glare effects on one hand, and on the other hand, it also has excellent wear resistance.

The transmittance of the anti-glare film 10 provided by the embodiments of the present disclosure can reach 85% or above, with a haze ranging from 5% to 55%. The hardness test for a 500 g load-bearing pencil is 3 H or above, and the friction test for a 500 g steel velvet is 50 cycles or above.

The present disclosure verifies the performance of the optical film provided by the present disclosure by the following specific embodiments.

The preparation of the surface modified particle modification solution includes the following steps.

Silica with the particle size of 3 μm and the mass of 11 g, 0.1 g of HCL, 9 g of ultrapure water, and 15 g of tetrahydrofuran are added to a 250 mL round bottom flask to obtain a mixture, and the mixture is dispersed by ultrasound for 1 hour. Then 9 g of 3-aminopropyl monodimethylethoxysilane is added to the round bottom flask, and nitrogen gas is introduced. The mixture is vigorously stirred at 60° C. for 24 hours. Then the mixture is decomposed and separated into a colorless aqueous phase and a turbid organic phase containing the product. After evaporating the organic solvent from the organic phase, the remaining white viscous solution is dissolved in dichloromethane and extracted multiple times with ultrapure water. To remove trace amounts of moisture from the dichloromethane solution, MgSO₄ may be added as a desiccant, and the dichloromethane solution is stirred overnight and filtered. Subsequently, the dichloromethane solution is evaporated at 40° C. for 2 hours to obtain the first oily product.

Silica with the particle size of 50 nm and the mass of 5 g, 0.1 g of HCL, 9 g of ultrapure water, and 15 g of tetrahydrofuran are added to a 250 mL round bottom flask to obtain a mixture, and the mixture is dispersed by ultrasound for 1 hour. Then 15 g of 3-aminopropyl monodimethylethoxysilane is added to the round bottom flask, and nitrogen gas is introduced. The mixture is vigorously stirred at 60° C. for 48 hours. Then the mixture is decomposed and separated into a colorless aqueous phase and a turbid organic phase containing the product. After evaporating the organic solvent from the organic phase, the remaining white viscous solution is dissolved in dichloromethane and extracted multiple times with ultrapure water. To remove trace amounts of moisture from the dichloromethane solution, MgSO₄ may be added as a desiccant, and the dichloromethane solution is stirred overnight and filtered. Subsequently, the dichloromethane solution is evaporated at 40° C. for 2 hours to obtain the second oily product.

Four g of the first oily product, 4 g of the second oily product, 12 g of trimethylbenzene diisocyanate, 40 g of tetrahydrofuran, 140 mg of dibutyltin dilaurate, and 110 mg of p-hydroxybenzyl ether are added into a 250 mL round bottom flask to obtain a solution, and nitrogen gas is introduced. The solution is stirred at 40° C. for 5 hours to obtain a pre-modified particle modification solution.

Forty g of the aforementioned pre-modified particle modification solution, 5 g of pentaerythritol triacrylate, 40 g of tetrahydrofuran, 160 mg of dibutyltin dilaurate, and 118 mg of p-hydroxybenzyl ether to a 250 mL round bottom flask to obtain a solution, and nitrogen gas is introduced. Then the solution is stirred at 40° C. for 5 hours to obtain the modified particle modification solution.

Due to the presence of the solvent in the prepared surface modified particle modification solution, according to the inventor's testing calculation, the content of the surface modified particles in the particle modification solution is 50% relative to the total mass of the particle modification solution. Calculated based on 100 parts of the resin, when the amount of the surface modified particle modification solution ranges from 10 to 50 parts, the corresponding amount of the surface modified particles may range from 5 to 25 parts.

Anti-glare layers 12 are prepared on a substrate 11 using the anti-glare composition containing the surface modified particle modification solution prepared in the above embodiments and a composition containing unmodified particles respectively, to obtain anti-glare films prepared in embodiments 1-6 and comparative examples 1-8. The film thickness of the anti-glare layers 12 in each embodiment and comparative example is same, and is 3 μm. The preparation methods are same (referring to the coating and curing process of existing technologies), but the components and contents in the anti-glare composition are different.

Embodiment 1: the anti-glare film includes 100 parts of 6-functional polyurethane acrylate (resin), 10 parts of pentaerythritol tetraacrylate (monomer), 5 parts of 1-hydroxycyclohexyl phenyl ketone (photo-initiator), 10 parts of the surface modified particle modification solution, and 500 parts of ethyl acetate (solvent).

Embodiment 2: the difference between this embodiment and the embodiment 1 is that the amount of the surface modified particle modification solution is 30 parts.

Embodiment 3: the difference between this embodiment and the embodiment 1 is that the amount of the surface modified particle modification solution is 50 parts.

Embodiment 4: the differences between this embodiment and the embodiment 1 are that the resin is 100 parts of 9-functional polyester acrylate, the monomer is 15 parts of trimethylolethane triacrylate, the photo-initiator is 6 parts of ethyl phenyl (2,4,6-trimethylbenzoyl) phosphinate, and the solvent is 560 parts of methyl ethyl ketone.

Embodiment 5: the difference between this embodiment and the embodiment 4 is that the amount of the surface modified particle modification solution is 30 parts.

Embodiment 6: the difference between this embodiment and the embodiment 4 is that the amount of the surface modified particle modification solution is 50 parts.

Comparative example 1: the difference between this embodiment and the embodiment 1 is that the particle is 10 parts of unmodified silica particle with a particle diameter of 3 μm.

Comparative example 2: the difference between this embodiment and the embodiment 1 is that the particle is 30 parts of unmodified silica particle with a particle diameter of 3 μm.

Comparative example 3: the difference between this embodiment and the embodiment 1 is that the particle is 50 parts of unmodified silica particle with a particle diameter of 3 μm.

Comparative example 4: the difference between this embodiment and the embodiment 4 is that the particle is 10 parts of unmodified silica particle with a particle diameter of 3 μm.

Comparative example 5: the difference between this embodiment and the embodiment 4 is that the particle is 30 parts of unmodified silica particle with a particle diameter of 3 μm.

Comparative example 6: the difference between this embodiment and the embodiment 4 is that the particle is 50 parts of unmodified silica particle with a particle diameter of 3 μm.

Comparative example 7: the difference between this embodiment and the embodiment 1 is that the amount of the surface modified particle modification solution is 5 parts.

Comparative example 8: the difference between this embodiment and the embodiment 1 is that the amount of the surface modified particle modification solution is 100 parts.

Performance tests are conducted on transmittance, haze, pencil hardness, and steel velvet friction of the anti-glare film prepared in embodiments 1-6 and comparative examples 1-8, respectively. The testing conditions for each implementation and reference are the same. The test data is shown in Table 1.

TABLE 1

| | | | Hardness test | 500 g |
|---|---|---|---|---|
| | | | for a 500 g | steel |
| | Transmittance | Haze | load-bearing | velvet |
| Anti-glare film | (%) | (%) | pencil | (cycle) |
| Embodiment 1 | 90 | 5 | 5 H | 100 |
| Embodiment 2 | 89 | 32 | 4 H | 80 |
| Embodiment 3 | 88 | 54 | 3 H | 56 |
| Embodiment 4 | 90 | 6 | 5 H | 120 |
| Embodiment 5 | 90 | 33 | 4 H | 88 |
| Embodiment 6 | 89 | 53 | 3 H | 67 |
| Comparative | 89 | 6 | H | 30 |
| example 1 | | | | |
| Comparative | 88 | 34 | H | 10 |
| example 2 | | | | |
| Comparative | 87 | 57 | HB | 5 |
| example 3 | | | | |
| Comparative | 88 | 8 | 2 H | 35 |
| example 4 | | | | |
| Comparative | 88 | 35 | H | 15 |
| example 5 | | | | |
| Comparative | 87 | 56 | H | 7 |
| example 6 | | | | |
| Comparative | 90 | 3 | 6 H | 130 |
| example 7 | | | | |
| Comparative | 90 | 60 | HB | 40 |
| example 8 | | | | |

The higher the hardness of a 500 g load-bearing pencil and the higher the friction value of 500 g steel velvet, the higher the hardness and wear resistance of the anti-glare film. From the test results, it can be seen that the hardness and wear resistance of the anti-glare films in the embodiments 1-6 are better than those of the anti-glare films in the comparative examples 1-6. The possible reason is that the surface modified particles of the anti-glare composition provided in the embodiments of the present disclosure include the second particle structures with small particle sizes, which have higher particle hardness and are difficult to be crushed by external forces to damage the structure. In addition, the surface modified particles can form a cross-linked network structure with the resin and the reactive monomer, further enhancing the hardness of the film.

The higher the haze, the better the light scattering effect and anti-glare effect. From the comprehensive performance of the wear resistance and anti-glare effect of the anti-glare film, the comprehensive performance of the anti-glare film in the embodiments 1-3 is better than that of the anti-glare film in the comparative examples 7-8. The possible reason is that the content of the surface modified particles in the resin of the anti-glare film has an impact on balancing the hardness and anti-glare performance. When the amount of the surface modified particle modification solution ranges from 10 parts to 50 parts (i.e., the amount of the surface modified particles (excluding solvents) ranges from 5 parts to 25 parts), the anti-glare film provided in the embodiments of the present disclosure has good wear resistance and anti-glare performance.

Referring to FIG. 2, the embodiments of the present disclosure further provide a polarizer 100, including a polarizing layer 20 and the anti-glare film 10 of the above embodiments. The anti-glare film 10 is disposed on a a light emitting side of the polarizing layer 20. The uneven surface of the anti-glare layer 12 of the anti-glare film is disposed on a side of the anti-glare layer 12 away from the polarizing layer 20.

The polarizing film 100 includes a hard coating layer disposed on the light emitting side of the polarizing layer 20. Due to the good hardness of the anti-glare film, the anti-glare film 10 can be reused as the hard coating layer.

The embodiments of the present disclosure further provide a display device, including a display panel and the polarizer 100 disposed on a light emitting side of the display panel. The display device may be an organic light-emitting diode (OLED) display device, a liquid crystal display device, a quantum dot display device, or a mini/micro light-emitting diode (LED) display device.

In summary, the embodiments of the present disclosure provide the anti-glare composition, the anti-glare film, the polarizer, and the display device. The anti-glare composition includes the resin and the surface modified particles. The surface modified particle includes the first particle, the second particle, and the hydrophobic modified group. The hydrophobic modified group is connected to both the first particle and the second particle through chemical bonds. The particle diameter of the first particle is larger than the particle diameter of the second particle. The particles of the anti-glare composition are modified by using hydrophobic modification groups to connect the large-sized first particle and the small-sized second particles, and hydrophobically modifying the two types of particles. On the one hand, the surface energy of the modified particles is reduced. When manufacturing the anti-glare film, the modified particles will aggregate towards the surface of the film. The large-sized first particle may form a continuous concave convex surface, which can effectively achieve anti-glare effect. On the other hand, the small-sized second particle aggregates around the large-sized first particle through chemical bonds. Due to the high particle hardness of the small-sized second particle, it is difficult to be crushed by external forces to damage the structure, so the anti-glare composition has excellent wear resistance.

The anti-glare composition, the anti-glare film, the polarizer, and the display device provided in the embodiments of the present disclosure are described in detail above. The principle and implementations of the present disclosure are described in this specification by using specific examples. The description about the foregoing embodiments is merely provided to help understand the method and core ideas of the present disclosure. In addition, persons of ordinary skill in the art can make modifications in terms of the specific implementations and application scopes according to the ideas of the present disclosure. Therefore, the content of this specification shall not be construed as a limit to the present disclosure.

What is claimed is:

1. An anti-glare composition, comprising a resin and a surface modified particle, wherein the surface modified particle comprises a first particle, a second particle, and a hydrophobic modified group, the hydrophobic modified group is connected to both the first particle and the second particle through chemical bonds, and a particle diameter of the first particle is larger than a particle diameter of the second particle.

2. The anti-glare composition of claim 1, wherein the first particle and the second particle comprise silica particles, and the particle diameter of the first particle ranges from 1 μm to 10 μm, and the particle diameter of the second particle ranges from 10 nm to 1000 nm.

3. The anti-glare composition of claim 2, wherein a structural formula of the surface modified particle is

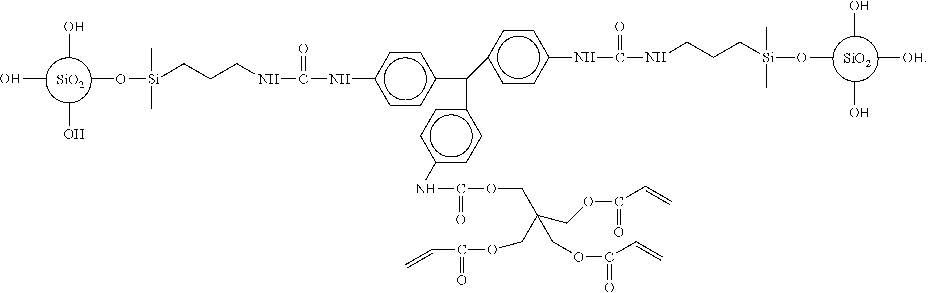

4. The anti-glare composition of claim 1, wherein the anti-glare composition comprises components with following content, calculated by 100 parts by weight of the resin:
the resin having 100 parts;
the surface modified particle having 5 to 25 parts;
a reactive monomer having 5 to 30 parts; and
an initiator having 1 to 10 parts.

5. The anti-glare composition of claim 4, wherein the hydrophobic modified group comprises carbon-carbon double bonds, and a cross-linked network structure is formed by the surface modified particle and the resin and/or the reactive monomer.

6. The anti-glare composition of claim 4, wherein a refractive index of the resin ranges from 1.4 to 1.6, a refractive index of the first particle ranges from 1.4 to 1.6, and a refractive index of the second particle ranges from 1.4 to 1.6.

7. The anti-glare composition of claim 4, wherein a functionality of the resin is greater than or equal to 5, and/or a functionality of the reactive monomer is greater than or equal to 3.

8. The anti-glare composition of claim 4, wherein,
the resin comprises at least one of polyester acrylic resin, polyurethane acrylic resin, epoxy acrylic resin, and polysilsesquioxane resin;
and/or, the reactive monomer comprises at least one of trimethylolethane tri(meth)acrylate, trimethylolpropane tri(meth)acrylate, glycerol tri(meth)acrylate, pentaerythritol tri(meth)acrylate, di(trimethylolpropane) tri(meth)acrylate, dipentaerythritol tri(meth)acrylate, pentaerythritol tetra(meth)acrylate, di(trimethylolpropane) tetra(meth)acrylate, dipentaerythritol tetra(meth)acrylate, dipentaerythritol penta(meth)acrylate, di(trimethylolpropane) penta(meth)acrylate, dipentaerythritol hexa(meth)acrylate, and di(trimethylolpropane) hexa(meth)acrylate;
and/or, the initiator comprises one of 4-phenoxydichlorophenone, 4-tert butyldichlorophenone, 4-tert butyltrichlorophenone, diethylacetophenone, 2-hydroxy-2-methyl-1-phenylpropane-1-one, 1-(4-isopropylphenyl)-2-hydroxy-2-methylpropane-1-one, 1-(4-dodecylphenyl)-2-hydroxy-2-methylpropane-1-one, 4-(2-hydroxyethoxy)-phenyl-(2-hydroxy-2-propyl) ketone, 1-hydroxycyclohexyl phenyl ketone, benzoin, benzoin methyl ether, benzoin ether, benzyl dimethyl ketal, acyl phosphine oxide, titanocene, benzophenone, benzoylbenzoic acid, benzoylbenzoic acid methyl ether, 4-phenylbenzophenone, hydroxybenzophenone, 4-benzoyl-4′-methyldiphenyl sulfide, 3,3′-dimethyl-4-methoxy benzophenone, thioxanthone, 2-chlorothioxanthone, 2-methylthioxanthone, 2,4-dimethylthioxanthone, and isopropylthioxanthone.

9. A polarizer, comprising a polarizing layer and an anti-glare film disposed on a light emitting side of the polarizing layer, wherein the anti-glare film comprises a substrate and an anti-glare layer disposed on the substrate, the anti-glare layer is manufactured by an anti-glare composition, the anti-glare layer comprises an uneven surface, and the anti-glare composition comprises a resin and a surface modified particle, wherein the surface modified particle comprises a first particle, a second particle, and a hydrophobic modified group, the hydrophobic modified group is connected to both the first particle and the second particle through chemical bonds, and a particle diameter of the first particle is larger than a particle diameter of the second particle.

10. The polarizer of claim 9, the first particle and the second particle comprise silica particles, and the particle diameter of the first particle ranges from 1 μm to 10 μm, and the particle diameter of the second particle ranges from 10 nm to 100 nm.

11. The polarizer of claim 10, wherein a structural formula of the surface modified particle is

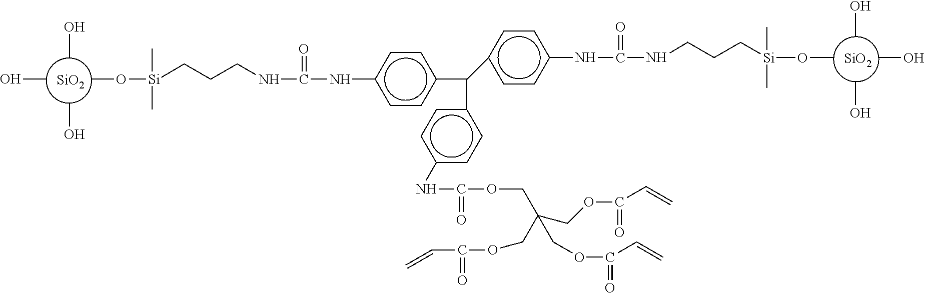

12. The polarizer of claim 9, wherein the anti-glare composition comprises components with following content, calculated by 100 parts by weight of the resin:
the resin having 100 parts;
the surface modified particle having 5 to 25 parts;
a reactive monomer having 5 to 30 parts; and
an initiator having 1 to 10 parts.

13. The polarizer of claim 12, wherein the hydrophobic modified group comprises carbon-carbon double bonds, and a cross-linked network structure can be formed by the surface modified particle and the resin and/or the reactive monomer.

14. The polarizer of claim 12, wherein a refractive index of the resin ranges from 1.4 to 1.6, a refractive index of the first particle ranges from 1.4 to 1.6, and a refractive index of the second particle ranges from 1.4 to 1.6.

15. The polarizer of claim 9, wherein the polarizer comprises a hard coating layer disposed on the light emitting side of the polarizing layer, and the anti-glare film is reused as the hard coating layer.

16. A display device, comprising a display panel and a polarizer disposed on a light emitting side of the display panel, wherein the polarizer comprises a polarizing layer and an anti-glare film disposed on a light emitting side of the polarizing layer, and the anti-glare film comprises a substrate and an anti-glare layer disposed on the substrate, wherein the anti-glare layer is manufactured by an anti-glare composition, the anti-glare layer comprises an uneven surface, and the anti-glare composition comprises a resin and a surface modified particle, wherein the surface modified particle comprises a first particle, a second particle, and a hydrophobic modified group, the hydrophobic modified group is connected to both the first particle and the second particle through chemical bonds, and a particle diameter of the first particle is larger than a particle diameter of the second particle.

17. The display device of claim 16, wherein the first particle and the second particle comprise silica particles, and the particle diameter of the first particle ranges from 1 μm to 10 μm, and the particle diameter of the second particle ranges from 10 nm to 100 nm.

18. The display device of claim 17, wherein a structural formula of the surface modified particle is

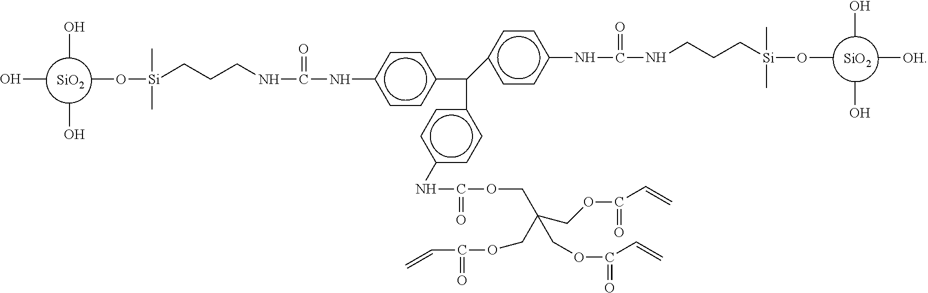

19. The display device of claim 16, wherein the anti-glare composition comprises components with following content, calculated by 100 parts by weight of the resin:
the resin having 100 parts;
the surface modified particle having 5 to 25 parts;
a reactive monomer having 5 to 30 parts; and
an initiator having 1 to 10 parts.

20. The display device of claim 19, wherein the hydrophobic modified group comprises carbon-carbon double bonds, and a cross-linked network structure can be formed by the surface modified particle and the resin and/or the reactive monomer.
